(19) United States
(12) Patent Application Publication
(10) Pub. No.: US 2010/0173205 A1
(43) Pub. Date: Jul. 8, 2010

(54) ELECTRODE GROUP FOR USE IN A LITHIUM ION BATTERY

(75) Inventors: Yu-qun Zeng, GuangDong (CN); Yue-li Wang, Guangdong (CN); Kun Liu, GuangDong (CN); Jian Tu, GuangDong (CN); Kai Wu, GuangDong (CN)

Correspondence Address: QUINN LAW GROUP, PLLC, 39555 ORCHARD HILL PLACE, SUITE # 520, NOVI, MI, 48375, US

(73) Assignees: Dongguan Amperex Electronics Technology Limited, Dongguan (CN); Dongguan Amperex Technology Limited, Guangdong (CN)

(21) Appl. No.: 12/640,722

(22) Filed: Dec. 17, 2009

(30) Foreign Application Priority Data
Jan. 8, 2009 (CN) CN200920049806.4

(51) Int. Cl. H01M 4/00; H01M 2/14

(52) U.S. Cl. 429/246

(57) ABSTRACT

An electrode group is configured for use in a lithium ion battery. The electrode group includes an anode plate and a cathode plate wound with a separator interposed therebetween. At least one metal oxide layer is disposed between the anode plate and the cathode plate. The metal oxide layer is provided at two length edges of the anode plate and/or the cathode plate, corresponding to the cutting edge of the cathode current collector where the cut burr formed in cutting process. Even though the cut burrs can pierce through the separator, the cut burrs still cannot contact the anode film. Any internal circuit short, caused by contact between the aluminum foil and the anode film, may therefore be avoided and, therefore, the performance of the lithium ion battery is remarkably improved.

### CROSS-REFERENCE TO RELATED APPLICATION

The present patent invention claims priority to Chinese Patent Application No. CN 200920049806.4 filed Jan. 8, 2009, which is incorporated by reference herein in its entirety.

### FIELD OF THE INVENTION

The present invention relates to lithium ion batteries and, more specifically, to an electrode group for use in a lithium ion battery.

### BACKGROUND OF THE INVENTION

Recently, with the development of science and technology, portable electronic devices, such as video cameras, laptop personal computers, portable DVDs and personal digital assistants are becoming increasingly popular in people's daily life. As a desirable power source for portable electronic devices, a lithium ion battery is widely used because of high energy density, high working voltage and long life span. At present, lithium ion batteries have gradually substituted other traditional batteries and been spread in aircrafts, vehicles and medical equipments.

Typically, a lithium ion battery (not shown) includes a number of battery cells (not shown) connected to each other in series or in parallel. Each battery cell includes a strip anode plate and a strip cathode plate spirally wound together with a separator disposed therebetween. The anode plate includes an anode current collector of copper foil and an anode film containing anode active materials formed on the anode current collector. The cathode plate includes a cathode current collector of aluminum foil and a cathode film containing cathode active materials provided on the cathode current collector. The separator is a micro porous film obtained via plasticization and extraction, which can keep the electrolyte and electrically insulate the anode plate from the cathode plate.

At present, the electrolyte in the lithium ion batteries is generally combustible organic electrolyte. Therefore, special attention should be paid to the performance of the lithium ion battery.

However, the aluminum cathode current collector of the cathode plate tends to form barb-shaped projections (hereinafter simply referred as cut burrs) on the cutting edge thereof in the manufacturing process. The cut burrs will potentially pierce through the separator between the anode plate and the cathode plate, which will sometimes cause direct contact between the aluminum foil and the anode film and, consequently, internal short circuit of the lithium ion battery. Due to the internal short circuit, the temperature in the lithium ion battery will rise quickly, which will potentially leads to the ignition of the organic electrolyte and even explosion of the lithium ion battery.

What is needed, therefore, is to provide an electrode group for use in lithium ion battery which can avoid the accidents as previously discussed.

### SUMMARY OF THE INVENTION

One object of the present invention is to provide an electrode group which has desirable performance for use in a lithium ion battery.

According to one embodiment of the present invention, an electrode group for use in a lithium ion battery includes an anode plate and a cathode plate wound with a separator interposed therebetween. At least one metal oxide layers is disposed between the anode plate and the cathode plate. The metal oxide layers are formed at two length edges of the anode plate and/or the cathode plate and extend along a length direction of the anode plate and/or the cathode plate.

According to one embodiment of the present invention, the metal oxide layers disposed between the cathode plate and the anode plate are corresponding to the length edges of the cathode current collector, i.e. the cutting edge of cathode current collector, where the cut burrs most possibly generated during the cutting process. Therefore, the cut burrs formed on the cutting edge of the cathode current collector can not pierce through the separator readily. Even though the cut burrs formed on the cutting edge of the cathode current collector can pierce through the separator, they still can not be in direct contact with the anode film. In view of the foregoing, internal circuit short accident caused by direct contact between the aluminum foil and the anode film is effectively avoided and the performance of the lithium ion battery is improved remarkably.

Specifically, the anode plate or the cathode plate, the metal oxide layer and the separator jointly enclose a chamber.

Specifically, the anode plate includes an anode current collector and an anode film containing anode active materials formed on the anode current collector, the oxide metal layers are disposed at two length edges of the anode film.

Specifically, the anode current collector is provided with at least one anode exposed portion without anode film disposed thereon, the exposed portion is disposed at one length end of the anode plate and is formed with an anode terminal.

Specifically, the metal oxide layers are symmetrically disposed at two length edges of the anode film.

Specifically, upper and lower surfaces of the anode plate are both coated with anode films and the metal oxide layers are coated at two length edges of each anode film.

Specifically, the cathode plate includes a cathode current collector and a cathode film containing cathode active materials coated on the cathode current collector, the metal oxide layers are disposed at two length edges of the cathode film.

Specifically, the metal oxide layers are symmetrically disposed at two length edges of the cathode film.

Specifically, the cathode films are provided on upper and lower surfaces of the cathode plate, the metal oxide layers are formed at two length edges of each cathode film. Specifically, the metal oxide layer is an alumina layer, a magnesia layer, or a silica layer.

Other advantages and novel features will be drawn from the following detailed description of preferred embodiments with the attached drawings, in which:

### BRIEF DESCRIPTION OF THE DRAWINGS

FIG. 1 depicts a top view of a strip anode plate for use in an electrode group according to a first embodiment of the present invention;

FIG. 2 depicts a side view of the anode plate shown in FIG. 1 along a direction A;

FIG. 3 depicts an enlarged cross-sectional view of the anode plate as shown in FIG. 1 along a line B-B;

FIG. 4 depicts an illustrative cross-sectional view of an electrode group having an anode plate, a cathode plate and a separator disposed therebetween according to a first embodiment of the present invention; and

FIG. 5 depicts an illustrative cross-sectional view of an electrode group having an anode plate and a cathode plate with a separator interposed therebetween according to a second embodiment of the present invention.

### DETAILED DESCRIPTION OF THE INVENTION

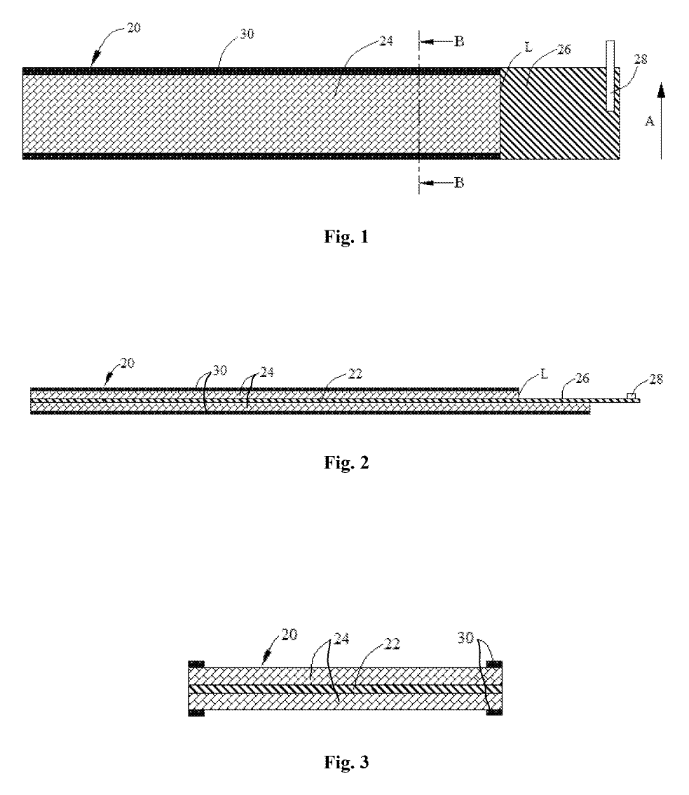

Referring to FIGS. 1 to 3, a belt-like anode plate 20 for use in an electrode group according to a first embodiment of the present invention includes a belt-like anode current collector 22 and an anode film 24 containing anode active materials formed on the anode current collector 22. In the illustrated embodiment, the anode current collector 22 is made from copper foil.

Referring to the left side as shown in FIG. 2, the anode films 24 on the upper and lower surfaces of the anode current collector 22 can be in alignment with each other, or not in alignment with each other as shown in the right side of FIG. 2. The anode current collector 22 is provided with at least one anode exposed portion 26 without anode film 24 carried thereon on at least one of the upper and lower surfaces thereof. In the illustrated embodiment, the anode exposed portion 26 is provided at one length end of the anode current collector 22, i.e. the right end of the current collector 22 as shown in FIG. 2. The anode exposed portion 26 is formed with an anode terminal 28.

Metal oxide layers 30 are symmetrically formed on two length edges of the anode film 24, i.e. the upper and lower edges of the anode film 24 as shown in FIG. 1. The metal oxide layers 30 each extends horizontally in a length direction of the anode plate 20 and perpendicular to the boundary line L of the anode film 24 and the anode exposed portion 26. It should be noticed that, the metal oxide layers 30 can completely enclose the two length edges of the anode film 24 where the cutting burrs are most likely formed in the manufacturing process. In the illustrated embodiment of the present invention, the metal oxide layer is an alumina (Al₂O₃) layer. However, according to other embodiments of the present invention, the metal oxide layer can also be a magnesia layer (MgO), a silica layer (SiO₂), or other metal oxide layers which also can prevent the aluminum foil and the anode film from directly contacting each other.

Referring to FIG. 4, the electrode group according to the first embodiment of the present invention adopts a customary cathode plate 40 and a customary separator 50. The cathode plate 40 has a cathode current collector 42 and a cathode film 44 containing cathode active materials formed on the cathode current collector 42. In the illustrated embodiment, the cathode current collector 42 is made from aluminum foil. The separator 50 is a micro porous film obtained from plasticization and extraction to keep the organic electrolyte containing lithium salts.

In the manufacturing process of the lithium ion battery, the strip anode plate 20 and the cathode plate 40, with the separator 50 interposed therebetween, are operatively connected to one another to form a determined shape. More specifically, in the embodiments shown, the strip anode plate 20, the cathode plate 40, and the separator 50 are spirally wound together to form an electrode group with a determined shape. The wound electrode group is packed in the battery pack foil and then electrolyte is filled.

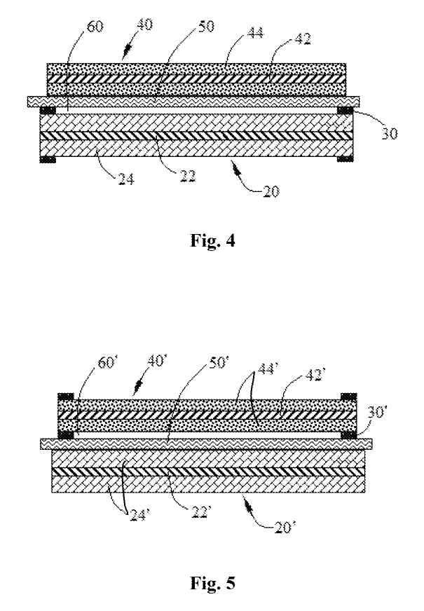

Referring particularly to FIG. 5, in accordance with a second embodiment of the present invention, a belt-like cathode plate 40′ includes a cathode current collector 42′ and a cathode film 44′ containing cathode active materials formed on the cathode current collector 42′. In the illustrated embodiment, the cathode current collector 42′ is made from aluminum foil. The cathode films 44′ on upper and lower surfaces of the cathode current collector 42′ can be configured to align with each other or not align with each other. The cathode current collector 42′ is formed with at least one cathode exposed portion (not shown) on at least one of the upper and lower surfaces thereof. The cathode exposed portion is formed with a cathode terminal (not shown).

Two opposite length edges of the cathode film 44′, i.e. the left edge and the right edge as illustrated in FIG. 5 are symmetrically formed with two metal oxide layers 30′ coating thereon, respectively. The metal oxide layers 30′ each extends along a length direction of the cathode plate 40′, i.e. a direction perpendicular to the paper surface.

The electrode group in accordance with the second embodiment of the present invention adopt a customary anode plate 20′ and a customary separator 50′. The anode plate 20′ includes an anode current collector 22′ and an anode film 24′ containing anode active materials formed on the anode current collector 22′. In the illustrated embodiment, the anode current collector 22′ is made from copper foil. The structure of the separator 50′ and the manufacturing process of the electrode group are similar to what have been detailed in the first embodiment of the present invention and will not be detailed again.

It should be understood that the embodiments as detailed previously, and the drawings as shown, are only intended to clearly describe the metal oxide layers 30, 30′, the relative position between the anode exposed portion 26 and the anode terminal 28 or the cathode terminal (not shown), are not intended to limit the specific shapes thereof. Additionally, the length and the thickness of each element as illustrated in the drawings are not strictly corresponding to the actual size thereof.

According to the embodiments of the present invention as previously detailed, the metal oxide layers 30, 30′ disposed between the cathode plate 40, 40′ and the anode plate 20, 20′ are corresponding to cutting edges of the cathode current collector 42, 42′ where the cut burrs most possibly generated during a cutting process. Therefore, the cut burrs on the cutting edges of the cathode current collector 42, 42′ cannot pierce through the separator 50, 50′ easily. Even though the cut burrs on the cutting edge of the cathode current collector 42, 42′ can pierce through the separator 50, 50′, they still cannot be in direct contact with the anode film 24, 24′. Summarizing the foregoing, an internal circuit short may result from direct contact between the aluminum foil and the anode film 24, 24′ is effectively avoided and performance of the lithium ion battery is improved remarkably.

Additionally, because of the arrangement of the metal oxide layers 30, 30′, the anode plate 20, 20′ is separated from the adjacent cathode plate 40, 40′ via a chamber 60, 60′ jointly enclosed by the separator 50, 50′, the metal oxide layer 30, 30′ and the anode plate 20, 20′ or the cathode plate 40, 40′. The size of the chamber 60, 60′ can be adjusted via changing a thickness of the metal oxide layer 30, 30′. As well known in the art, in the charge of the lithium ion battery, the anode plate 20, 20′ will expand. The expansion will sometimes lead to the crack of the anode plate 20, 20′ of copper foil. However, the chamber 60, 60′ disposed between the adjacent anode plate 20, 20′ and the cathode plate 40, 40′ according to the present invention can provide additional space for the expansion of the anode plate 20, 20′ and, therefore, can effectively prevent the anode plate 20, 20′ from breaking.

It should be noticed that, according to the present invention, the metal oxide layers 30, 30′ are coated on two length edges of the anode film 24 or the cathode film 44′. With respect to the whole area of the anode plate 20 or the cathode plate 40′, the metal oxide layers 30, 30′ only occupies a very small portion. The arrangement of the metal oxide layers 30, 30′ according to the present invention can remarkably improve the performance of the lithium ion battery without adversely effect the circle performance thereof.

While the present invention has been illustrated by the above description of the preferred embodiments thereof, while the preferred embodiments have been described in considerable detail, it is not intended to restrict or in any way limit the scope of the appended claims to such details. Additional advantages and modifications within the spirit and scope of the present invention will readily appear to those ordinary skilled in the art. Consequently, the present invention is not limited to the specific details and the illustrative examples as shown and described.

What is claimed is:

1. An electrode group for use in a lithium ion battery, the electrode group comprising:
an anode plate and a cathode plate with a separator interposed therebetween;
wherein the anode plate, the cathode plate, and the separator are operatively attached to one another; and
at least one metal oxide layer disposed between the anode plate and the cathode plate, the metal oxide layer being formed at two length edges one of the anode plate and the cathode plate and extending along a length direction of the one of the anode plate and the cathode plate.

2. The electrode group of claim 1, wherein the metal oxide layer, the separator, and the one of the anode plate and the cathode plate jointly enclose a chamber.

3. The electrode group of claim 1, wherein the anode plate comprises an anode current collector and an anode film containing anode active material formed on the anode current collector, the metal oxide layers are disposed at two length edges of the anode film.

4. The electrode group of claim 3, wherein the anode current collector is provided with at least one anode exposed portion without anode film formed thereon, the exposed portion is disposed at one length end of the anode plate and is provided with an anode terminal.

5. The electrode group of claim 3, wherein the metal oxide layers are symmetrically disposed at two length edges of the anode film.

6. The electrode group of claim 5, wherein upper and lower surfaces of the anode plate are coated with anode films and the metal oxide layers are coated on two length edges of each anode film.

7. The electrode group of claim 1, wherein the cathode plate comprises a cathode current collector and a cathode film containing cathode active material formed on the cathode current collector, the metal oxide layers are disposed at two length edges of the cathode film.

8. The electrode group of claim 7, wherein the metal oxide layers are symmetrically disposed at two length edges of the cathode film.

9. The electrode group of claim 8, wherein the cathode films are formed on upper and lower surfaces of the cathode plate and the metal oxide layers are formed at two length edges of the cathode film.

10. The electrode group of claim 1, wherein the metal oxide layer is one of an alumina layer, a magnesia layer, and a silica layer.

11. The electrode group of claim 1, wherein the anode plate, the cathode plate, and the separator are spirally wound such that the anode plate, the cathode plate, and the separator are operatively attached to one another.
